(19) United States
(12) Patent Application Publication
(10) Pub. No.: US 2020/0108309 A1
(43) Pub. Date: Apr. 9, 2020

(54) GAME PROGRAM, AND GAME PROGRAM CONTROL METHOD

(71) Applicant: SQUARE ENIX CO., LTD., Tokyo (JP)

(72) Inventors: Yasuhiro KIDERA, Tokyo (JP); Hirohito SUZUKI, Tokyo (JP)

(73) Assignee: SQUARE ENIX CO., LTD., Tokyo (JP)

(21) Appl. No.: 16/489,105

(22) PCT Filed: Feb. 28, 2017
(86) PCT No.: PCT/JP2017/007868

§ 371 Date: Aug. 27, 2019

(51) Int. Cl. A63F 13/216; A63F 13/65

(52) U.S. Cl. CPC A63F 13/216; A63F 13/65

(57) ABSTRACT

To reduce a possibility of a difference between regions in a game that uses the position of a player terminal is an object. To storage the information related to the game medium group configured with the plurality of game media in association with the region in the real world. To transmit, to the player terminal, the information related to the game medium group corresponding to the region to which the position of the player terminal in the real world belongs. To displays one or more game media constituting the game medium group based on the received information related to the game medium group.

### TECHNICAL FIELD

The present invention relates to a game program, and game program control method.

### BACKGROUND ART

In the related art, a game that uses the position of a player terminal measured using a position measuring system such as GPS is known. For example, PTL 1 discloses a game that stores a virtual current location of an electronic pet in a computer apparatus in association with a position in a real world, and displays the electronic pet on a player terminal and gives the electronic pet to a player in a case where the position of the player terminal is the position in the real world corresponding to the virtual current location of the electronic pet.

### CITATION LIST

### Patent Literature

Patent Literature 1: JP-A-2011-204115

### SUMMARY OF INVENTION

### Technical Problem

However, in the method of centrally managing the virtual current location of a game medium and the position in the real world in one-to-one correspondence in the computer apparatus as in PTL 1, for example, a difference in the number of appearances of the game medium may arise between regions such as a region in which a large number of game media appear and a region in which the game medium almost does not appear. A player living in the region in which the game medium almost does not appear may not be able to sufficiently enjoy the game.

An object of at least one embodiment of the present invention is to solve the problem and reduce the possibility of a difference between regions in a game that uses the position of a player terminal.

### Solution to Problem

According to a non-limiting aspect, a game program executed in a computer apparatus connectable by communication to a player terminal operated by a player, the program causing the computer apparatus to function as: a storage that stores information related to a game medium group configured with a plurality of game media in association with a region in a real world; a receiver that receives positional information related to a position of the player terminal in the real world; and a transmitter that transmits, to the player terminal, the information related to the game medium group corresponding to the region to which the position indicated by the received positional information belongs, wherein the player terminal transmits the positional information related to the position of the player terminal in the real world to the computer apparatus, receives the information related to the game medium group corresponding to the region to which the position of the player terminal in the real world belongs from the computer apparatus, and displays one or more game media constituting the game medium group based on the received information related to the game medium group.

According to a non-limiting aspect, a method for controlling a game program executed in a computer apparatus connectable by communication to a player terminal operated by a player, the method comprising: a storage step of storing information related to a game medium group configured with a plurality of game media in association with a region in a real world; a reception step of receiving positional information related to a position of the player terminal in the real world; and a transmission step of transmitting, to the player terminal, the information related to the game medium group corresponding to the region to which the position indicated by the received positional information belongs, wherein the player terminal transmits the positional information related to the position of the player terminal in the real world to the computer apparatus, receives the information related to the game medium group corresponding to the region to which the position of the player terminal in the real world belongs from the computer apparatus, and displays one or more game media constituting the game medium group based on the received information related to the game medium group.

### Advantageous Effects of Invention

One or more of the above problems can be solved with each embodiment of the present invention.

### BRIEF DESCRIPTION OF THE DRAWINGS

FIG. 1 is a block diagram illustrating a configuration of a computer apparatus which corresponds to at least one embodiment of the present invention.

FIG. 2 is a flowchart of a program execution process which corresponds to at least one embodiment of the present invention.

FIG. 3 is a block diagram illustrating a configuration of a computer apparatus which corresponds to at least one embodiment of the present invention.

FIG. 4 is a flowchart of a program execution process which corresponds to at least one embodiment of the present invention.

FIG. 5 is a block diagram illustrating a configuration of a game system which corresponds to at least one embodiment of the present invention.

FIG. 6 is a flowchart of a program execution process which corresponds to at least one embodiment of the present invention.

FIG. 7 is a block diagram illustrating a configuration of a player terminal which corresponds to at least one embodiment of the present invention.

FIG. 8 is a flowchart of a program execution process which corresponds to at least one embodiment of the present invention.

FIG. 9 is a block diagram illustrating a configuration of a game system which corresponds to at least one embodiment of the present invention.

FIG. 10 is a block diagram illustrating a configuration of a computer apparatus which corresponds to at least one embodiment of the present invention.

FIG. 11 is a block diagram illustrating a configuration of a player terminal which corresponds to at least one embodiment of the present invention.

FIG. 12 is a block diagram illustrating a configuration of a game system which corresponds to at least one embodiment of the present invention.

FIG. 13 is a flowchart of a program execution process which corresponds to at least one embodiment of the present invention.

FIG. 14 is one example of a correspondence data table showing the region in the real world and the information related to the game medium group which corresponds to at least one embodiment of the present invention.

FIG. 15 is one example of the display screen displayed on a player terminal which corresponds to at least one embodiment of the present invention.

FIG. 16 is one example of a display screen displayed on a player terminal which corresponds to at least one embodiment of the present invention.

FIG. 17 is one example of a correspondence data table showing the given game medium, the positional information related to the player terminal in a case where the game medium is given, and the like which corresponds to at least one embodiment of the present invention.

FIG. 18A and FIG. 18B are one example of a display screen displayed on a player terminal which corresponds to at least one embodiment of the present invention.

### DESCRIPTION OF EMBODIMENTS

Hereinafter, embodiments of the invention will be described with reference to the accompanying drawings. Hereinafter, description relating to effects shows an aspect of the effects of the embodiments of the invention, and does not limit the effects. Further, the order of respective processes that form a flowchart described below may be changed in a range without contradicting or creating discord with the processing contents thereof.

### First Embodiment

First, an outline of a first embodiment of the present invention will be described. In the following description, a game program that is executed in a computer apparatus connectable by communication to a player terminal operated by a player will be illustratively described as the first embodiment.

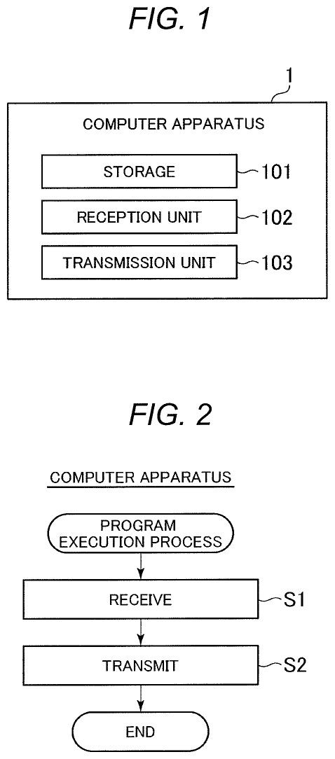

FIG. 1 is a block diagram illustrating a configuration of a computer apparatus which corresponds to at least one embodiment of the present invention. A computer apparatus 1 includes at least a storage 101, a reception unit 102, and a transmission unit 103.

The storage 101 has a function of storing information related to a game medium group configured with a plurality of game media in association with a region in a real world. The reception unit 102 has a function of receiving positional information related to the position of the player terminal in the real world. The transmission unit 103 has a function of transmitting, to the player terminal, the information related to the game medium group corresponding to the region to which the position indicated by the positional information received by the reception unit 102 belongs.

Next, a program (game program) execution process in the first embodiment of the present invention will be described. FIG. 2 is a flowchart of a program execution process which corresponds to at least one embodiment of the present invention.

The computer apparatus 1 receives the positional information related to the position of the player terminal in the real world (step S1). Next, the computer apparatus 1 transmits, to the player terminal, the information related to the game medium group corresponding to the region to which the position indicated by the positional information received in step S1 belongs (step S2), and terminates the program execution process. The information which is related to the game medium group and is transmitted in step S2 is the information which is related to the game medium group configured with the plurality of game media and is stored in the storage 101 in association with the region in the real world.

The player terminal transmits the positional information related to the position of the player terminal in the real world to the computer apparatus. In addition, the player terminal receives, from the computer apparatus, the information related to the game medium group corresponding to the region to which the position of the player terminal in the real world belongs. In addition, the player terminal displays one or more game media constituting the game medium group based on the received information related to the game medium group.

As one aspect of the first embodiment, the possibility of a difference between regions in a game that uses the position of the player terminal can be reduced.

In the first embodiment, the “player terminal” refers to a terminal such as a mobile phone, a smartphone, a tablet computer, a personal computer, a portable game console, a stationary game console, or the like that can communicate with the computer apparatus and can perform the game execution process. For example, the “player” refers to a user who operates the player terminal and plays the game. For example, the “computer apparatus” refers to an apparatus that executes a process according to a request from the player terminal. For example, the “game” refers to a computer game executed by running the program in the computer apparatus and/or the player terminal. The content of the game may be in any genre.

For example, the “game medium” refers to digital contents used by the player in the game and is exemplified by a card, a character, a weapon, armor, an item, or an avatar. For example, the “information related to the game medium group” refers to an image of each game medium associated with the region in the real world or a status such as offensive power and defensive power. In addition, the “information related to the game medium group” may include the appearance probability of each game medium. For example, the “region in the real world” refers to a region having a predetermined area such as a region in nation-level units, prefecture-level units, or municipal-level units, or a specific region (for example, Tokyo Station). The “positional information” refers to information related to the current position of the player terminal in the real world measured using, for example, a GPS sensor included in the player terminal or a wireless network system of the player terminal. The “position” is not limited to a two-dimensional position indicated by a latitude and a longitude and may be a concept including a height.

### Second Embodiment

Next, an outline of a second embodiment of the present invention will be described. In the following description, a game program that is executed in a computer apparatus connectable by communication to a player terminal operated by a player will be illustratively described as the second embodiment.

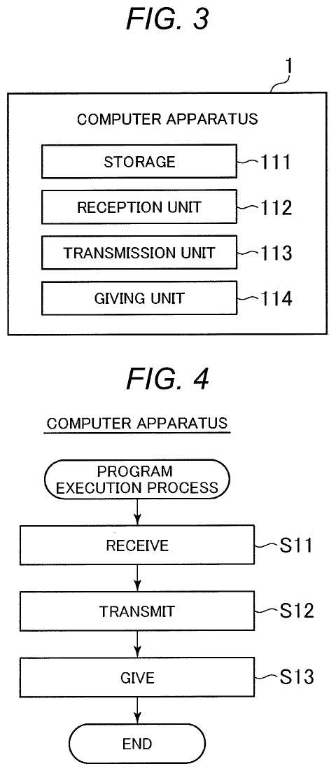

FIG. 3 is a block diagram illustrating a configuration of a computer apparatus which corresponds to at least one embodiment of the present invention. The computer apparatus 1 includes at least a storage 111, a reception unit 112, a transmission unit 113, and a giving unit 114.

The storage 111 has a function of storing information related to a game medium group configured with a plurality of game media in association with a region in the real world. The reception unit 112 has a function of receiving positional information related to the position of the player terminal in the real world. The transmission unit 113 has a function of transmitting, to the player terminal, the information related to the game medium group corresponding to the region to which the position indicated by the positional information received by the reception unit 112 belongs. The giving unit 114 has a function of giving the game medium displayed on the player terminal to the player in a case where the result of the game satisfies a predetermined condition.

Next, a program (game program) execution process in the second embodiment of the present invention will be described. FIG. 4 is a flowchart of a program execution process which corresponds to at least one embodiment of the present invention.

The computer apparatus 1 receives the positional information related to the position of the player terminal in the real world (step S11). Next, the computer apparatus 1 transmits, to the player terminal, the information related to the game medium group corresponding to the region to which the position indicated by the positional information received in step S11 belongs (step S12). The information which is related to the game medium group and is transmitted in step S12 is the information which is related to the game medium group configured with the plurality of game media and is stored in the storage 111 in association with the region in the real world. Next, in a case where the result of the game satisfies a predetermined condition, the computer apparatus 1 gives the game medium displayed on the player terminal to the player (step S13) and terminates the program execution process.

The player terminal transmits the positional information related to the position of the player terminal in the real world to the computer apparatus. In addition, the player terminal receives, from the computer apparatus, the information related to the game medium group corresponding to the region to which the position of the player terminal in the real world belongs. The player terminal displays one or more game media constituting the game medium group based on the received information related to the game medium group.

As one aspect of the second embodiment, the givable game medium varies depending on the position of the player terminal. Thus, the interest of the game can be improved.

In the second embodiment, regarding each of the “player terminal”, the “player”, the “computer apparatus”, the “game”, the “game medium”, the “information related to the game medium group”, the “region in the real world”, and the “positional information”, the contents disclosed in the first embodiment can be adopted within a necessary range.

In addition, in the second embodiment, for example, the “predetermined condition” is exemplified by a success in an event for receiving the game medium. Specifically, the predetermined condition is exemplified by winning in a virtual battle with the displayed game medium or bringing the game medium into contact with a predetermined item by an operation performed on the player terminal. The “predetermined condition” is not limited to the above example and can be appropriately set depending on the genre and content of the game.

For example, “giving” refers to associating the game medium with the player and enabling the player to use the game medium in the game. For example, “associating the game medium with the player” refers to an update of player information such that information related to the game medium is included in the player information managed by the computer apparatus. In addition, “giving” includes a case such as rental where the player can use the game medium for a certain period.

### Third Embodiment

Next, an outline of a third embodiment of the present invention will be described. In the following description, a game program that is executed in a computer apparatus connectable by communication to a player terminal operated by a player will be illustratively described as the third embodiment.

Regarding a configuration of the computer apparatus in the third embodiment, the configurations illustrated in the block diagram in FIG. 3 can be adopted within a necessary range. In addition, regarding a flow of program execution process in the third embodiment, the flow illustrated in the flowchart in FIG. 4 can be adopted within a necessary range.

In the third embodiment, the storage 111 further has a function of storing information related to a game medium A given to the player by the giving unit 114. The transmission unit 113 further has a function of transmitting the information related to the game medium A to another player terminal operated by another player. The giving unit 114 further has a function of giving the game medium A to another player in a case where the result of the game in another player terminal satisfies a predetermined condition.

In the third embodiment, the information transmitted in step S12 further includes information related to the game medium given to another player. The information which is related to another game medium and is transmitted in step S12 is stored in the storage 111. In addition, in step S13, in a case where the result of the game in the player terminal satisfies the predetermined condition, the game medium that is given to another player and displayed on the player terminal is given to the player.

As one aspect of the third embodiment, by setting the game medium given to the player to be givable to another player, the game can have sociability, and the interest of the game can be improved.

In the third embodiment, regarding each of the “player terminal”, the “player”, the “computer apparatus”, the “game”, the “game medium”, the “information related to the game medium group”, the “region in the real world”, and the “positional information”, the contents disclosed in the first embodiment can be adopted within a necessary range.

In addition, in the third embodiment, regarding each of the “predetermined condition”, “giving”, and “associating the game medium with the player”, the contents disclosed in the second embodiment can be adopted within a necessary range. The “predetermined condition” may be different in the degree of difficulty between the player receiving a game medium first and another player receiving the information related to the game medium. For example, the “predetermined condition” may be set as a condition that is more difficult to another player than to the player receiving the game medium first.

In addition, in the third embodiment, for example, the “information related to the game medium” refers to information related to the image and status of the game medium or identification information (ID) that is related to the game medium and is necessary for specifying the image and status of the game medium. In addition, the “information related to the game medium” may further include information related to the player to which the game medium is given, the positional information related to the player terminal in a case where the game medium is given, and a time at which the information related to the given game medium is stored in the storage.

### Fourth Embodiment

Next, an outline of a fourth embodiment of the present invention will be described. In the following description, a game program that is executed in a computer apparatus connectable by communication to a player terminal operated by a player will be illustratively described as the fourth embodiment.

Regarding a configuration of the computer apparatus in the fourth embodiment, the configurations illustrated in the block diagram in FIG. 1 or FIG. 3 can be adopted within a necessary range. In addition, regarding a flow of program execution process in the third embodiment, the flows illustrated in the flowchart in FIG. 2 or FIG. 4 can be adopted within a necessary range.

In the fourth embodiment, the transmission unit 103 or the transmission unit 113 further has a function of transmitting information related to a map of the real world corresponding to a region to which the position of the player terminal belongs. The player terminal displays one or more game media constituting a game medium group on an image showing the map of the real world, based on received information related to the game medium group and the information related to the map.

As one aspect of the fourth embodiment, by displaying the game medium on the image showing the map of the real world, the ability of interaction between the game and the real world can be increased, and the interest of the game can be improved.

In the fourth embodiment, regarding each of the “player terminal”, the “player”, the “computer apparatus”, the “game”, the “game medium”, the “information related to the game medium group”, the “region in the real world”, and the “positional information”, the contents disclosed in the first embodiment can be adopted within a necessary range. In addition, in the fourth embodiment, for example, the “information related to the map” is information for displaying, on the player terminal, the map that corresponds to at least a part of the region to which the position of the player terminal belongs and that corresponds to a region within a predetermined distance from a reference with the position of the player terminal as the reference point (for example, a region within 5 Km from the position of the player terminal).

### Fifth Embodiment

Next, an outline of a fifth embodiment of the present invention will be described. In the following description, a game system implemented by a player terminal operated by a player and a computer apparatus connectable by communication to the player terminal will be illustratively described as the fifth embodiment.

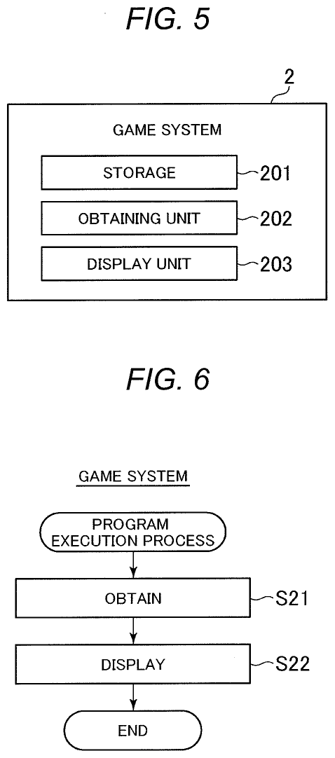

FIG. 5 is a block diagram illustrating a configuration of a game system which corresponds to at least one embodiment of the present invention. A game system 2 includes at least a storage 201, an obtaining unit 202, and a display unit 203.

The storage 201 has a function of storing information related to a game medium group configured with a plurality of game media in association with a region in the real world. The obtaining unit 202 has a function of obtaining positional information related to the position of the player terminal in the real world. The display unit 203 has a function of displaying one or more game media constituting the game medium group on the player terminal based on the information related to the game medium group corresponding to the region to which the position indicated by the positional information obtained by the obtaining unit 202 belongs.

Next, a program (game program) execution process in the fifth embodiment of the present invention will be described. FIG. 6 is a flowchart of a program execution process which corresponds to at least one embodiment of the present invention.

The game system 2 obtains the positional information related to the position of the player terminal in the real world (step S21). Next, the game system 2 displays one or more game media constituting the game medium group on the player terminal based on the information related to the game medium group corresponding to the region to which the position indicated by the obtained positional information belongs (step S22), and terminates the program execution process. The information related to the game medium group in step S22 is the information which is related to the game medium group configured with the plurality of game media and is stored in the storage 201 in association with the region in the real world.

As one aspect of the fifth embodiment, the possibility of a difference between regions in a game that uses the position of the player terminal can be reduced.

In the fifth embodiment, regarding each of the “player terminal”, the “player”, the “computer apparatus”, the “game”, the “game medium”, the “information related to the game medium group”, the “region in the real world”, and the “positional information”, the contents disclosed in the first embodiment can be adopted within a necessary range. In addition, in the fifth embodiment, for example, “obtaining the positional information” is exemplified by obtaining the positional information related to the current position of the player terminal in the real world using the GPS sensor, the wireless network system, or the like in the player terminal or receiving the positional information related to the player terminal in the computer apparatus.

### Sixth Embodiment

Next, an outline of a sixth embodiment of the present invention will be described. In the following description, a game program executed in a player terminal in a game system implemented by the player terminal operated by a player and a computer apparatus connectable by communication to the player terminal will be illustratively described as the sixth embodiment.

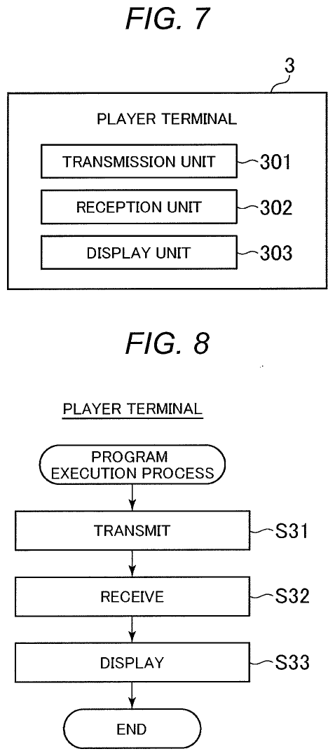

FIG. 7 is a block diagram illustrating a configuration of a player terminal which corresponds to at least one embodiment of the present invention. A player terminal 3 includes at least a transmission unit 301, a reception unit 302, and a display unit 303.

The transmission unit 301 has a function of transmitting positional information related to the position of the player terminal in the real world. The reception unit 302 has a function of receiving, from the computer apparatus, information related to a game medium group corresponding to a region to which the position of the player terminal in the real world belongs. The display unit 303 has a function of displaying one or more game media constituting the game medium group based on the information which is related to the game medium group and is received by the reception unit 302.

The game system stores the information related to the game medium group configured with a plurality of game media in association with the region in the real world. In addition, the game system receives the positional information related to the position of the player terminal in the real world. In addition, the game system transmits, to the player terminal, the information related to the game medium group corresponding to the region to which the position indicated by the received positional information belongs.

Next, a program (game program) execution process in the sixth embodiment of the present invention will be described. FIG. 8 is a flowchart of a program execution process which corresponds to at least one embodiment of the present invention.

The player terminal 3 transmits the positional information related to the position of the player terminal in the real world (step S31). Next, the player terminal 3 receives, from the computer apparatus, the information related to the game medium group corresponding to the region to which the position of the player terminal in the real world belongs (step S32). The information which is related to the game medium group and is transmitted in step S32 is the information which is related to the game medium group configured with the plurality of game media and is stored in the game system in association with the region in the real world. Next, the player terminal 3 displays one or more game media constituting the game medium group based on the received information related to the game medium group (step S33) and terminates the program execution process.

As one aspect of the sixth embodiment, the possibility of a difference between regions in a game that uses the position of the player terminal can be reduced.

In the sixth embodiment, regarding each of the “player terminal”, the “player”, the “computer apparatus”, the “game”, the “game medium”, the “information related to the game medium group”, the “region in the real world”, and the “positional information”, the contents disclosed in the first embodiment can be adopted within a necessary range.

### Seventh Embodiment

Next, an outline of a seventh embodiment of the present invention will be described. In the following description, a game system implemented by a player terminal operated by a player and a computer apparatus connectable by communication to the player terminal will be illustratively described as the seventh embodiment.

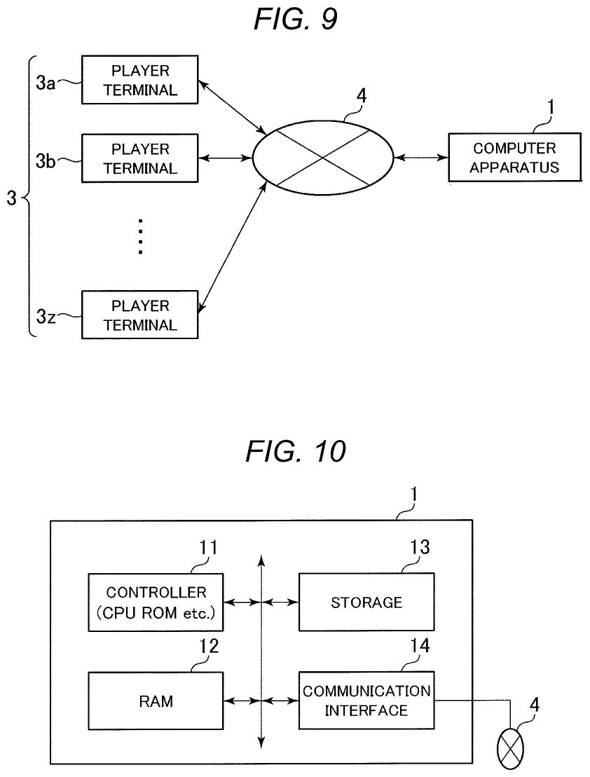

FIG. 9 is a block diagram illustrating a configuration of a game system which corresponds to at least one embodiment of the present invention. As illustrated, the game system is configured with the computer apparatus 1, a communication network 4, and a plurality of player terminals 3 (3a, 3b, . . . , 3z) operated by individual players. The computer apparatus 1 is connected to the player terminals 3 through the communication network 4. The computer apparatus 1 may not be constantly connected to the player terminals 3 and may be able to be connected as necessary.

FIG. 10 is a block diagram illustrating a configuration of a computer apparatus which corresponds to at least one embodiment of the present invention. The computer apparatus 1 includes at least a controller 11, a random access memory (RAM) 12, a storage 13, and a communication interface 14 that are connected to each other through an internal bus.

The controller 11 is configured with a central processing unit (CPU) and a read only memory (ROM), executes a program stored in the storage 13, and controls the computer apparatus 1. In addition, the controller 11 includes an internal timer that tracks time. The RAM 12 is a work area of the controller 11. The storage 13 is a storage region for storing the program (including a game program) and data (including game data). The controller 11 reads the program and the data from the RAM 12 and performs a program execution process based on information and the like received from the player terminals 3.

The communication interface 14 can be connected to the communication network 4 in a wireless or wired manner and can transmit and receive data through the communication network 4. For example, data received through the communication interface 42 is loaded into the RAM 12 and is subjected to a calculation process by the controller 11.

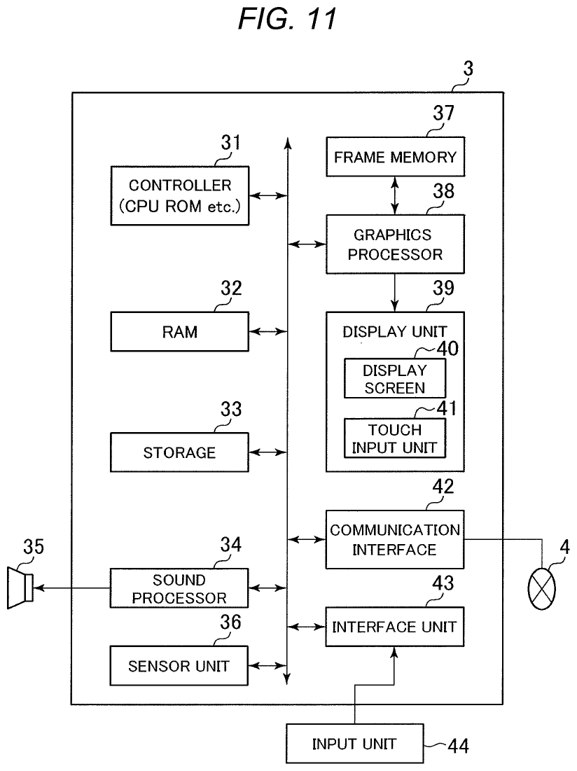

FIG. 11 is a block diagram illustrating a configuration of a player terminal which corresponds to at least one embodiment of the present invention. The player terminal 3 includes at least a controller 31, a RAM 32, a storage 33, a sound processor 34, a sensor unit 36, a graphics processor 38, a display unit 39, a communication interface 42, and an interface unit 43 that are connected to each other through an internal bus.

The controller 31 is configured with a CPU and a ROM. The controller 31 executes a program stored in the storage 33 and controls the player terminal 3. The RAM 32 is a work area of the controller 31. The storage 33 is a storage region for storing the program and data.

The controller 31 reads a program and data from the RAM 32 and processes the program and the data. By processing the program and the data loaded in the RAM 32, the controller 31 outputs a sound output instruction to the sound processor 34 and outputs an image rendering instruction to the graphics processor 38.

The sound processor 34 is connected to a sound output device 35 that is a speaker. In a case where the controller 31 outputs the sound output instruction to the sound processor 34, the sound processor 34 outputs a sound signal to the sound output device 35.

The sensor unit 36 includes a GPS sensor. In addition, the sensor unit 36 may include various other sensors. For example, various sensors are exemplified by a fingerprint authentication sensor, a proximity sensor, an acceleration sensor, a gyrosensor, a magnetic field sensor, a brightness sensor, or a barometric pressure sensor.

The graphics processor 38 is connected to the display unit 39. The display unit 39 includes a display screen 40. In a case where the controller 31 outputs the image rendering instruction to the graphics processor 38, the graphics processor 38 loads an image into a frame memory (frame buffer) 37 and outputs a video signal for displaying the image on the display screen 40. The display unit 39 may be a screen of a touch panel including a touch input unit 41.

The graphics processor 38 renders one image in frame units. For example, a time of one frame of the image is 1/30 seconds. The graphics processor 38 distributes the workload of the whole system by performing a part of a calculation process related to image rendering performed by only the controller 31.

The communication interface 42 can be connected to the communication network 4 in a wireless or wired manner and can transmit and receive data through the communication network 4. Data received through the communication interface 42 is loaded into the RAM 32 and is subjected to a calculation process by the controller 31 in the same manner as data read from an external memory.

An input unit 44 (for example, a mouse or a keyboard) may be connected to the interface unit 43. Input information provided by the player from the input unit 44 is stored in the RAM 32, and the controller executes various calculation processes based on the input information. Alternatively, a storage medium reading device can be connected to the interface unit 43, and a program, data, and the like can be read from the external memory. In addition, the display unit 39 including a touch panel can be used as the input unit 44.

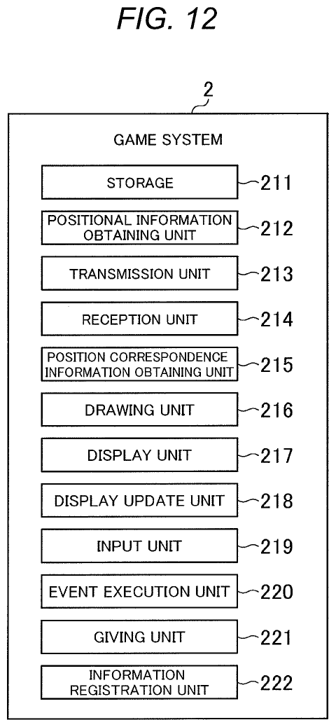

FIG. 12 is a block diagram illustrating a configuration of a game system which corresponds to at least one embodiment of the present invention. The game system 2 includes at least a storage 211, a positional information obtaining unit 212, a transmission unit 213, a reception unit 214, a position correspondence information obtaining unit 215, a drawing unit 216, a display unit 217, a display update unit 218, an input unit 219, an event execution unit 220, a giving unit 221, and an information registration unit 222.

The storage 211 has a function of storing information related to a game medium group configured with a plurality of game media in association with a region in the real world. For example, it is preferable that with a region having a predetermined area such as a nation, a prefecture, a municipality, or a specific region (for example, Tokyo Station or the summit of Mount Takao) as a unit, the information related to the game medium group is associated with each region unit. Such a configuration easily prevents a situation in which the information related to the game medium group is not associated with a location at which the player terminal is positioned, and the game medium is not displayed on the player terminal. An overlapping region may be present between the region units. In addition, the storage 211 preferably stores information for displaying a map corresponding to at least a part of the region unit on the player terminal.

The information related to the game medium group preferably includes the appearance probability of each game medium. Such a configuration can display a different game medium on each player terminal even in a case where the positions of two or more player terminals in the real world are the same, and can improve the interest of the game. For example, the appearance probability is preferably set depending on an attribute (rarity or the like) set for the game medium. For example, it is preferable to set the appearance probability to be decreased as the rarity of the game medium is increased.

The positional information obtaining unit 212 has a function of obtaining positional information related to the position of the player terminal in the real world. The positional information is preferably obtained by measuring the position using, for example, the GPS sensor included in the player terminal or a wireless network system of the player terminal. For example, the positional information is obtained as coordinates of a specific point.

The transmission unit 213 includes a transmission unit 213a included in the player terminal 3 and a transmission unit 213b included in the computer apparatus 1. The transmission unit 213a has a function of transmitting information related to a game to the computer apparatus 1 from the player terminal 3. For example, the positional information which is related to the player terminal and is obtained by the positional information obtaining unit 212, and information related to the result of the game (event) are transmitted to the computer apparatus 1 by the transmission unit 213a. The transmission unit 213b has a function of transmitting the information related to the game to the player terminal 3 from the computer apparatus 1. For example, the information related to the game medium group corresponding to the region to which the position indicated by the positional information related to the player terminal 3 belongs, information related to a map corresponding to the position, information related to the game medium given to another player, and information related to the game medium given to the player are transmitted to the player terminal 3 by the transmission unit 213b.

The reception unit 214 includes a reception unit 214a included in the player terminal 3 and a reception unit 214b included in the computer apparatus 1. The reception unit 214a has a function of receiving the information which is related to the game and is transmitted to the player terminal 3 from the computer apparatus 1 by the transmission unit 213b. The reception unit 214b has a function of receiving the information which is related to the game and is transmitted to the computer apparatus 1 from the player terminal 3 by the transmission unit 213a.

The position correspondence information obtaining unit 215 has a function of obtaining, from the storage 211, the information related to the game medium group corresponding to the region to which the position indicated by the positional information which is related to the player terminal and is received by the reception unit 214b belongs. It is preferable that along with the information related to the game medium group, the position correspondence information obtaining unit 215 obtains, from the storage 211, the information related to the map corresponding to at least a part of the region to which the position indicated by the positional information related to the player terminal belongs. The information which is related to the game medium group and is obtained by the position correspondence information obtaining unit 215 and the information which is related to the map and is obtained by the position correspondence information obtaining unit 215 are transmitted to the player terminal 3 from the computer apparatus 1 by the transmission unit 213b.

In addition, in a case where two or more region units have an overlapping part and the position of the player terminal is present in the overlapping part, the position correspondence information obtaining unit 215 may obtain the information related to the game medium group corresponding to all regions to which the position of the player terminal belongs. For example, a case where information related to a different game medium group is associated with each of a region in units of nations such as “Japan”, a region in units of provinces such as “Kanto province”, a region in units of prefectures such as “Tokyo Metropolis”, and a region in units of municipalities such as “Chiyoda Ward” and the player terminal is positioned in Chiyoda Ward will be described as an example. Since the player terminal is positioned in “Chiyoda Ward”, “Tokyo Metropolis”, “Kanto province”, and “Japan”, the position correspondence information obtaining unit 215 can be configured to obtain information related to a game medium group A associated with “Japan”, information related to a game medium group B associated with “Kanto province”, information related to a game medium group C associated with “Tokyo Metropolis”, and information related to a game medium group D associated with “Chiyoda Ward”. Such a configuration easily provides variations to the game medium displayed on the player terminal and uniqueness for each region unit and can improve the interest of the game.

In addition, in a case where two or more region units have an overlapping part and the position of the player terminal is present in the overlapping part, a drawing probability may be set for each region, and a region may be drawn based on the set drawing probability. The position correspondence information obtaining unit 215 may be configured to obtain the information related to the game medium group corresponding to the elected region. In the above example in which the player terminal is assumed to be positioned in Chiyoda Ward, for example, in a case where the drawing probability of “Japan” is set to 10%, the drawing probability of “Kanto province” is set to 20%, the drawing probability of “Tokyo Metropolis” is set to 30%, and the drawing probability of “Chiyoda Ward” is set to 40%, the position correspondence information obtaining unit 215 can be configured to draw any one region based on those drawing probabilities and obtain the information related to the game medium group corresponding to the elected region.

In addition, in a case where two or more region units have an overlapping part and the position of the player terminal is present in the overlapping part, whether being elected or not of each region may be drawn based on the election probability set for each region, and the information related to the game medium group corresponding to each of any one or more regions elected may be obtained. For example, the election probability of “Japan” may be set to 100%, the election probability of “Kanto province” may be set to 20%, the election probability of “Tokyo Metropolis” may be set to 30%, and the election probability of “Chiyoda Ward” may be set to 40%. Whether being elected or not of each region may be drawn based on those election probabilities, and the information related to the game medium group corresponding to each of any one or more elected regions may be obtained. For example, even in a case where the player does not move from a sphere of life including daily life, such a configuration can change the game medium appearing on the player terminal and can improve the interest of the game.

The drawing unit 216 has a function of drawing the game medium to be displayed on the player terminal 3 based on the information which is related to the game medium group and is received by the reception unit 214a. While the drawing may be randomly performed, it is preferable to perform the drawing based on the appearance probability set for each game medium. For example, by performing the drawing based on the appearance probability set for each game medium, the interest of the game can be improved by increasing or decreasing the frequency of appearance of each game medium.

In addition, the drawing unit 216 may perform the drawing after adjusting the basic appearance probability of the game medium included in the information received by the reception unit 214a, based on the status (for example, the level) of the player, the game medium possessed by the player, the item possessed or used by the player, the timing of playing the game (for example, morning, night, or an event period), and the like. For example, such a configuration can involve the player in adjusting the appearance probability of the game medium and cause the game medium desired to be given to the player to easily appear, or can increase the ability of interaction between the game and the real world by setting the displayed game medium to be different in the morning and at night. The satisfaction of the player and the interest of the game can be improved.

The display unit 217 has a function of displaying an image corresponding to the game medium drawn by the drawing unit 216 on the player terminal 3. The game medium displayed by the display unit 217 is the game medium drawn by the drawing unit 216 based on the information related to the game medium group corresponding to the region to which the position of the player terminal 3 belongs. That is, the game medium displayed by the display unit 217 is decided and displayed for each player terminal. Thus, regardless of the position of the player terminal, approximately the same number of game media can be displayed. Accordingly, the occurrence of a difference in number of appearances of the game medium between regions such as a region in which a large number of game media appear and a region in which the game medium almost does not appear, as in a game in the related art, can be prevented. Regardless of the region in which the player lives, a game of high satisfaction that the player can sufficiently enjoy can be provided.

The display unit 217 preferably includes an unidentifiable display unit 217a and an identifiable display unit 217b. The unidentifiable display unit 217a has a function of displaying the image corresponding to the game media in a state where the game medium is unidentifiable by the player. The “state where the game medium is unidentifiable by the player” may be a state where the image of the game medium cannot be identified (game medium cannot be identified) and is exemplified by, for example, a state where the game medium is displayed as a scratch image or a state where the game medium is displayed with a mosaicing process performed thereon. From the viewpoint of improving the interest of the game by an operation of virtually scraping the scratch image, it is preferable to display the game medium as the scratch image.

In addition, the unidentifiable display unit 217a preferably sets the image corresponding to the game medium to be different depending on the attribute of the game medium. For example, in a case where the unidentifiable display unit 217a displays the scratch image, it is preferable to set the type of scratch image to be different depending on the attribute of the game medium. Specifically, for example, the color or shape of the scratch image is set to be different, or a display effect added to the scratch image is set to be different depending on the rarity of the game medium. In such a state, for example, the expectation of the game medium displayed in a case where the scratch image is virtually scraped can be increased, and the interest of the game can be improved.

The identifiable display unit 217b has a function of changing the image displayed by the unidentifiable display unit 217a to a state where the game medium is identifiable by the player according to a predetermined operation performed on the player terminal. For example, according to a touch input on the touch panel of the player terminal, the identifiable display unit 217b changes the unidentifiable image of the game medium displayed at the location of the touch input to an identifiable image of the game medium. For example, a configuration in which the identifiable display unite 217b changes the display of a part corresponding to the location of the operation of virtually scraping the scratch image, to the image of the game medium in response to the operation, in a case where the scratch image is displayed by the unidentifiable display unit 217a, is exemplified. The “change the display” may be a state where the player can feel that the image is changed, and, for example, is exemplified by a state where the unidentifiable image displayed in superimposition on the identifiable image is removed or not displayed or a state where the identifiable image is displayed in superimposition on the unidentifiable image.

It is preferable that in the case of displaying a plurality of game media or images corresponding to the game media, the display unit 217, the unidentifiable display unit 217a, and the identifiable display unit 217b display each image in a non-overlapping manner. Such a configuration can improve the visibility of the player. In addition, the player can be caused to feel that a larger number of game media appear than in the case of displaying the game media in an overlapping manner, and the interest of the game can be improved.

The display update unit 218 has a function of updating and displaying the game medium displayed on the player terminal in a case where, for example, a predetermined time elapses from a time when the game medium is displayed by the display unit 217. For example, the predetermined time is 10 minutes, 30 minutes, or 1 hour and can be appropriately set depending on the content of the game. In addition, the predetermined time may be different for each game medium. For example, it is preferable to set the predetermined time depending on the rarity of the game medium. By including the display update unit 218, a time limit for acquiring the displayed game medium can be set, and the interest of the game can be improved. In addition, since the game medium intentionally left by the player can be changed to a new game medium after display of the game medium, the convenience of use of the player can be improved.

The input unit 219 has a function of receiving an operation input of the player. For example, the operation input of the player can be provided by operating a button, a stick, or the like included in the player terminal or performing a touch operation, a swipe operation, or the like on the touch panel included in the player terminal.

The event execution unit 220 has a function of executing an event (game) for acquiring the selected game medium in a case where the image of the game medium displayed by the display unit 217 is selected by an operation performed on the player terminal. The content of the event is not particularly limited and can be appropriately set depending on the content or genre of the game. For example, the content of the event is exemplified by a virtual battle with the selected game medium or a game of bringing a predetermined position of the selected game medium into contact with a predetermined item. In addition, the content of the event may be different depending on the attribute of the game medium.

The giving unit 221 has a function of giving the game medium displayed by the display unit 217 to the player in a case where the result of the event performed by the event execution unit 220 satisfies a predetermined condition. The “predetermined condition” can be appropriately set depending on the content of the event. For example, the predetermined condition is exemplified by winning in the virtual battle with the selected game medium or bringing the selected game medium into contact with the predetermined item.

The information registration unit 222 has a function of registering the information related to the game medium given to the player by the giving unit 221 in the storage 211. The registered information related to the game medium is transmitted to another player terminal by the transmission unit 213b and is displayed on the other player terminal by the display unit 217 included in the other player terminal. In a case where the result of the event in the other player terminal satisfies the predetermined condition, the game medium is given to the other player. By including the information registration unit 222, the information related to the game medium can be shared between a plurality of players. Thus, a sense of solidarity between the players can be improved.

The information which is related to the game medium and is registered in the information registration unit 222 includes information related to the image and status of the game medium or information related to identification information (ID) or the like that is related to the game medium and is necessary for specifying the image and status of the game medium. In addition, the information related to the game medium preferably includes information related to the player to which the game medium is given. By including the information related to the player to which the game medium given, for example, the name and the like of the player to which the game medium is given can be displayed on another player terminal, and the satisfaction of the player can be improved. In addition, by including the information related to the player to which the game medium is given, another player transmitting the information related to the game medium can be limited to another player associated with the player to which the game medium is given. For example, in adopting a state where the information related to the game medium given to the player is transmitted to only another player in a so-called friendly relationship with the player or a state where a predetermined benefit (for example, the game medium is set to be easily acquired) is given to another player in the friendly relationship in a case where the information related to the game medium given to the player is transmitted to another player in the friendly relationship, the players can actively interact with each other, and the sociability of the game can be increased.

In addition, the information related to the game medium preferably includes a time at which the information related to the given game medium is registered. By including the time of registration, for example, a period for transmitting the information related to the game medium to another player terminal and a period for storing information in the storage 211 can be easily limited, and the game balance can be easily adjusted. A time at which the game medium is given to the player may be stored instead of storing the time at which the information related to the given game medium is registered.

In addition, the information related to the game medium preferably includes the positional information related to the player terminal in a case where the game medium is given. By including the positional information related to the player terminal in a case where the game medium is given, for example, another player terminal transmitting the information related to the game medium can be decided based on the positional information related to the player terminal. For example, in adopting a state where the information related to the game medium is transmitted to only another player terminal positioned near the player terminal in a case where the game medium is given, the ability of interaction between the game and the real world is increased, and the interest of the game can be improved, and the regional uniqueness of the game medium can be increased.

In addition, it is preferable that the information registration unit 222 sets a condition for the registered game medium and registers only the game medium satisfying the condition. The condition for registration is not particularly limited and, for example, is exemplified such that the game medium has predetermined rarity or higher. For example, in such a configuration, only the information related to the game medium that is highly likely desired to be given by a large number of players can be transmitted to another player terminal, and the satisfaction of the player can be improved.

In addition, for example, the condition for registration may be the game medium displayed based on the information related to the game medium group. That is, in a case where another player secondarily receives the game medium based on the information related to the initially registered game medium, it is preferable not to register the information related to the secondarily given game medium. Such a configuration can prevent duplicate registration of the information related to the same game medium, and the game balance can be easily adjusted. The condition for registering the game medium may include one condition or a plurality of conditions.

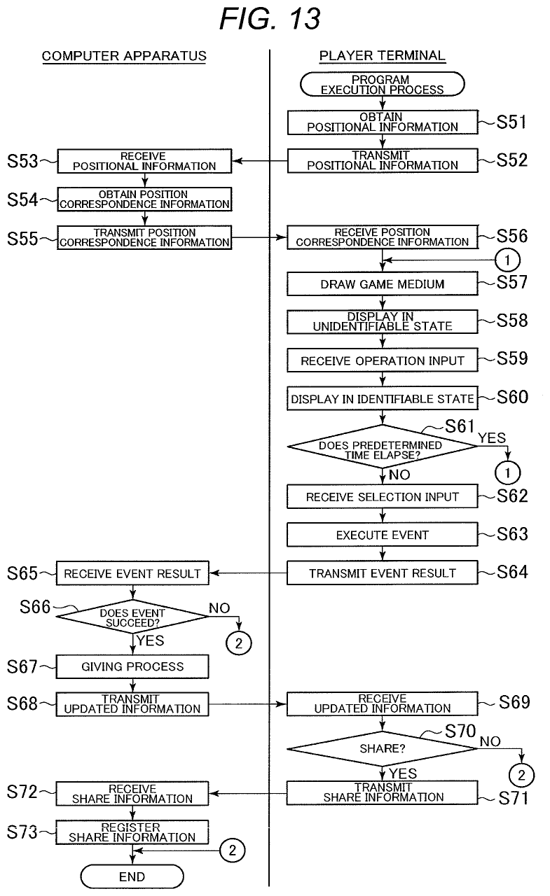

Next, a program execution process in the seventh embodiment of the present invention will be described. FIG. 13 is a flowchart of a program execution process which corresponds to at least one embodiment of the present invention.

In the following description, as an example of the game, a role playing game in which the game progresses using the positional information related to the player terminal and the game medium possessed by the player (available for the player) will be described. The genre of the game is not limited to the role playing game. For example, the program execution process can be applied to a simulation game or an action game regardless of genre.

A status (for example, offensive power, defensive power, and the maximum hit point) used in the game, a skill having a predetermined effect, and the like are set for the game medium. The player selects any one of the game media from possessed game media and, for example, performs the event for receiving the game medium or virtually battles with an enemy character or another player. The result of the event, winning or losing in the virtual battle, and the like are decided based on the status, the skill, and the like set for the game medium. In addition, the rarity is set for the game medium. It is preferable that as the rarity of the game medium is increased, rareness in the game is increased, and the election probability (appearance probability) in the case of executing the drawing for displaying the game medium on the player terminal is set to be decreased. In addition, it is preferable to set a higher status used in the game for the game medium of high rarity than for the game medium of low rarity.

The information related to the game medium group configured with the plurality of game media is stored in the computer apparatus in association with the region in the real world. In addition, the information related to the map corresponding to at least a part of the region in the real world is stored in the computer apparatus. For example, information related to the game medium possessed by the player is managed by the computer apparatus or the player terminal as player information. In the case of giving the game medium to the player, the player information is updated such that information related to the given game medium is included in the player information.

First, in the player terminal, the positional information related to the position of the player terminal in the real world is obtained (step S51). The positional information is obtained by measuring the position using, for example, the GPS sensor included in the player terminal or the wireless network system of the player terminal. Next, the player terminal transmits the positional information obtained in step S51 to the computer apparatus (step S52).

Next, the computer apparatus receives the positional information related to the player terminal from the player terminal (step S53). Next, the computer apparatus obtains, from the storage 13 of the computer apparatus, the information related to the game medium group corresponding to the region to which the position indicated by the received positional information belongs, and the information related to the map corresponding to at least a part of the region (step S54). The information obtained in step S54 may include information that is related to the game medium shared by other players and is registered in step S73 described below.

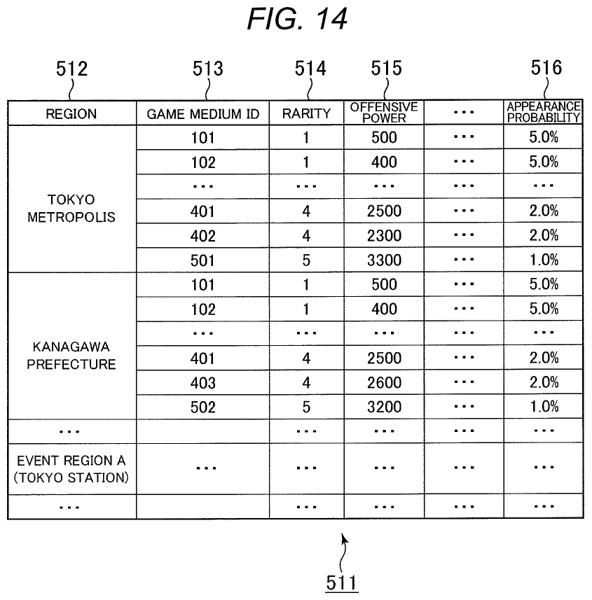

FIG. 14 is one example of a correspondence data table showing the region in the real world and the information related to the game medium group which corresponds to at least one embodiment of the present invention. A correspondence data table 511 stores a game medium ID 513, rarity 514, offensive power 515, and an appearance probability 516 in association with a region 512. A known method can be used for defining each region included in the region 512 without particular limitations. For example, each region can be defined in a latitude and longitude coordinate system using a latitude and a longitude. In addition, the correspondence data table 511 is merely one example and may include other information. While a case where the correspondence data table 511 is stored in the storage 13 of the computer apparatus is described below as an example, the correspondence data table 511 may be stored in any of the storage 33 of the player terminal or the external memory.

In the example in FIG. 14, game media having the game medium ID 513 of “101”, “102”, . . . , “401”, “402”, and “501” are associated with “Tokyo Metropolis” in the region 512. The rarity, offensive power, and the appearance probability shown in the rarity 514, the offensive power 515, and the appearance probability 516 are set for the game medium corresponding to each game medium ID. Game media having the game medium ID 513 of “101”, “102”, . . . , “401”, “403”, and “502” are associated with “Kanagawa Prefecture” in the region 512. The game medium ID associated with each region shown in the region 512 may be completely different from each other or may be partially overlapped each other as shown in the example in FIG. 14. In addition, for example, information related to the same game medium group may be associated with a region A and a region B.

The appearance probability 516 may be set such that the total of the appearance probability 516 in each region is 100%, or may be set such that the total is less than 100%. For example, in a case where the total of appearance probability is set to be less than 100%, “100%−total value of appearance probability” can be regarded as a losing probability or the probability of giving an item, a point, or the like to the player in step S57 described below.

In a case where the region to which the position indicated by the positional information received in step S53 belongs is “Tokyo Metropolis”, information related to the game media having the game medium ID of “101”, “102”, . . . , “401”, “402”, and “501” is obtained as the information related to the game medium group in step S54. In addition, in a case where the position indicated by the positional information received in step S53 also belongs to a region “event region A (Tokyo Station)”, information associated with each of “Tokyo Metropolis” and the “event region A (Tokyo Station)” may be obtained together, or only information associated with either of two regions may be obtained in step S54. From the viewpoint of obtaining the game medium associated with the event region easily and improving the participation rate of players in the event, it is preferable to obtain only the information associated with the “event region A (Tokyo Station)”.

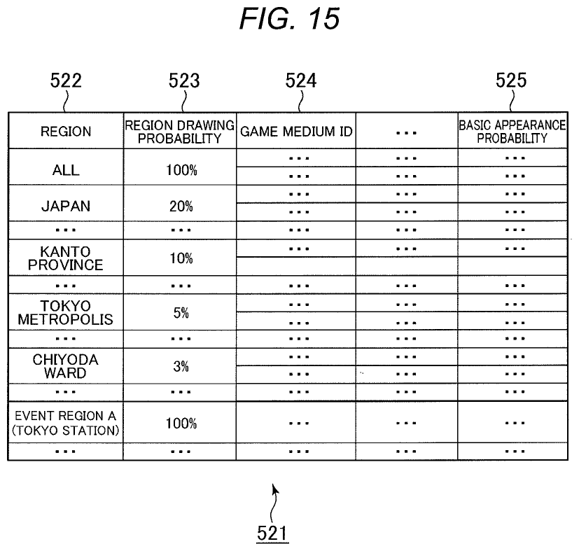

FIG. 15 is a modification example of the correspondence data table shown in FIG. 14 and is one example of a correspondence data table showing the region in the real world and the information related to the game medium group which corresponds to at least one embodiment of the present invention. A correspondence data table 521 stores a region drawing probability 523, a game medium ID 524, and a basic appearance probability 525 of the game medium in association with a region 522. While a case where the correspondence data table 521 is stored in the storage 13 of the computer apparatus is described below as an example, the correspondence data table 521 may be stored in any of the storage 33 of the player terminal or the external memory.

In the region 522, “all” is a region including a position in the world, “Japan” is a region including a position in Japan, “Kanto province” is a region including a position in Kanto province, “Tokyo Metropolis” is a region including a position in Tokyo Metropolis, “Chiyoda Ward” is a region including a position in Chiyoda Ward, and the “event region A (Tokyo Station)” is a region including a position in Tokyo Station. Each region exemplified above includes an overlapping part.

In the example in FIG. 15, in a case where the position of the player terminal is in Tokyo Station, first, a region is drawn based on the region drawing probability 523 in step S54. Specifically, each region is drawn with the election probability of “Japan” set to 30%, the election probability of “Kanto province” set to 20%, the election probability of “Tokyo Metropolis” set to 10%, and the election probability of “Chiyoda Ward” set to 5%. For example, in a case where “Kanto province” and “Chiyoda Ward” are elected, information related to the game medium group corresponding to “all” and the “event region A (Tokyo Station)” for which the region drawing probability 523 is set to 100% are obtained in step S54 in addition to information related to the game medium group corresponding to “Kanto province” and “Chiyoda Ward”.

In this case, in the drawing of the game medium in step S57 described below, for example, it is preferable to adjust the actual appearance probability of each game medium based on the basic appearance probability 525 set for the game medium corresponding to each region. A method of adjusting the appearance probability is not particularly limited and, for example, preferably includes setting a predetermined weight for each region and adjusting the actual appearance probability. For example, such a configuration can give the game medium corresponding to a specific region such as the event region to the player, and the giving of the game medium in accordance with the intention of a game administrator is easily performed.

In addition, in the modification example of the above, the total of the region drawing probability of each region may be adjusted to 100% for all regions to which the position of the player terminal belongs, and any one region may be drawn based on the adjusted region drawing probability. In this case, the regions of “all” and the “event region A (Tokyo Station)” may not be included in the drawing target, and the information related to the game medium group corresponding to those regions may be obtained at all times. In such a configuration, the game medium corresponding to the region as the event region is easily given to the player, and game management can be performed in accordance with the intention of the game administrator. In addition, in the above configuration, for example, by associating the region “all” with a common game medium of low rarity, storing the common game medium of low rarity in duplicate between regions can be reduced.

The flowchart in FIG. 13 will be described again. The computer apparatus transmits the information which is related to the game medium group and is obtained in step S54 to the player terminal (step S55). Next, the player terminal receives the information from the computer apparatus (step S56).

Next, the player terminal draws the game medium to be displayed on the player terminal based on the appearance probability of the game medium included in the information received in step S56 (step S57). For example, the drawing of the game medium is repeated multiple times such that a predetermined number of game media can be displayed. While an example in which the drawing of the game medium is executed in the player terminal is exemplified in the present embodiment, the drawing of the game medium may be performed in the computer apparatus. In such case, information related to the result of drawing is transmitted to the player terminal from the computer apparatus.

Next, the player terminal displays the drawn game medium on the display screen in a state unidentifiable by the player along with the image of the map depicting the surrounding area of the position of the player terminal (step S58). In addition, in a case where the information which is related to the game media shared by other players and is registered in step S73 described below is received in step S56, for example, the shared game media is also displayed with the total number of displayed game media not exceeding a predetermined number. The display position of the displayed game medium (including the game medium displayed in an unidentifiable state) on the display screen is controlled such that each game medium is not displayed in overlapping with each other.

Next, the player terminal receives a predetermined operation input from the player (step S59) and changes the image displayed in a state where the game medium is unidentifiable by the player to a state where the game medium is identifiable by the player (step S60).

Next, a determination as to whether or not a predetermined time elapses from a time when the game medium displayed in step S60 is displayed on the display screen is performed (step S61). In a case where the predetermined time elapses (Yes in step S61), the image of the game medium is removed from the display screen, and step S57 is performed again. In a case where the predetermined time does not elapse (No in step S61), an operation input for selecting the displayed game medium is provided (step S62), and an event for acquiring the selected game medium is executed (step S63). The content of the event is not particularly limited and may be appropriately set depending on the content of the game.

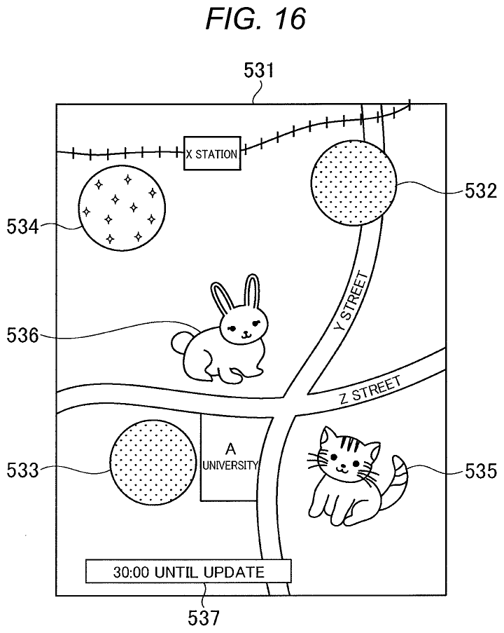

FIG. 16 is one example of a display screen displayed on a player terminal which corresponds to at least one embodiment of the present invention. Scratch images 532 to 534, game media 535 and 536, and an update time display field 537 are displayed on a display screen 531 on the map corresponding to the position of the player terminal in the real world. From the viewpoint of improving visibility, it is preferable to display the map on the display screen 531 such that the position of the player terminal on the map is near the center of the display screen. In addition, from the viewpoint of improving the convenience of use of the player, for example, it is preferable that the scale of the map displayed on the display screen can be changed by a pinch operation or a button operation on the touch panel.

The scratch images 532 to 534 are the game media drawn in step S57 displayed in a state unidentifiable by the player. The scratch image 534 has diamond shapes unlike the scratch images 532 and 533. The diamond shapes indicate that the game medium displayed in a case where the scratch image 534 is virtually scraped has high rarity. By setting the display state of the scratch image to be different depending on the rarity of the game medium, the expectation of the player in the case of scraping a specific scratch image can be increased, and the interest of the game can be improved. The display state of the scratch image may be set such that the color of the scratch image may be set to be different, or the display effect added to the scratch image may be set to be different. In addition, the display state of the scratch image may be set to be different depending on the attribute of the game medium other than rarity.

In addition, in a case where a predetermined item is used on the scratch image corresponding to the game medium of low rarity such as the scratch image 532, the game medium may be redrawn such that the game medium of high rarity is drawn. For example, in a case where the predetermined item is used on the scratch image 532, the scratch image 532 may be changed to be in a display state such as the scratch image 534, and the game medium may be redrawn from the game media of high rarity at the timing of virtually scraping the changed scratch image. For example, the predetermined item is exemplified by an item given by paying a charge or an item given depending on the moving distance of the player terminal in the real world. By adopting such a configuration, opportunities of the player to acquire the game medium of high rarity can be increased, and the satisfaction of the player can be increased.

In addition, in a case where the rarity of the drawn game medium is high, the scratch image 534 may be displayed from the beginning as a scratch image corresponding to the game medium. However, from the viewpoint of further increasing the interest of the game, it is preferable to first display a scratch image corresponding to the game medium of low rarity such as the scratch image 532 and then, display the scratch image 534 instead of the scratch image after the scratch image is virtually scraped. Such a configuration can increase the joy of scraping the scratch image.

The game medium 535 is a game medium that is displayed in a state identifiable by the player by an operation of virtually scraping the scratch image. For example, in a case where an operation of virtually scraping the scratch image 532 is performed, the game medium corresponding to the scratch image 532 is displayed in a state identifiable by the player like the game medium 535. In a case where the game medium 535 is selected by an operation performed by the player, an event for acquiring the game medium 535 is executed, and the game medium 535 is given to the player depending on the result of the event.

The game medium 536 is a game medium selected by the player from the game media possessed by the player. The game medium 536 is displayed at the position of the player terminal on the map displayed on the display screen 531. From the viewpoint of improving the interest of the game, for example, it is preferable to change the display of the game medium 536 depending on the moving speed of the player terminal. Specifically, in a case where the player terminal is moving at a general walking speed of a person, the image of the game medium 536 is displayed as walking. In a case where the player terminal is moving at a speed that is only possible in a case where the player terminal is carried by automobile or the like, the image of the game medium 536 is displayed as flying.

In addition, the appearance probability of each game medium in the drawing of the game medium in step S57 may be adjusted using the game medium 536. For example, in a case where species such as “rabbit species” and “cat species” are set as the attribute of the game medium, the appearance probability of the game medium of the same species as the game medium 536 may be adjusted to be increased. In addition, the appearance probability may be adjusted based on the effect of the skill or the like set for the game medium 536. In such a configuration, the drawing probability of the game medium can be adjusted by selection of the player. Thus, for example, the game medium desired to be given by the player can be set to easily appear, and the satisfaction of the player can be improved.

In addition, the event executed in step S63 may use the game medium 536. For example, based on the status, skill, attribute, or the like of the game medium 536, a virtual battle between the game medium 536 and the game medium 535 may be performed, or the success rate of the event may be changed. Such a configuration can motivate the player to collect various game media such as a game media having high rarity, a game medium having excellent status or the like or a game medium having a good correlation with the game medium desired to be acquired.

The update time display field 537 displays a time until the scratch images 532 to 534 and the game medium 535 are updated. In a case where the time displayed in the update time display field 537 becomes equal to zero, the scratch images 532 to 534 and the game medium 535 are removed. Then, the game medium is drawn, and a new scratch image is displayed at any position not in overlapping with other scratch images or the images of other game medium. The update time may be individually set for each scratch image and each game medium. In the case of such a configuration, the update time is preferably displayed near each scratch image and each game medium. In addition, in a case where the image of the game medium or the scratch image in a different display state is displayed by virtually scraping the scratch image, it is preferable to reset the update time.

The flowchart in FIG. 13 will be described again. The player terminal transmits the information related to the result of the event executed in step S63 to the computer apparatus (step S64). For example, the information related to the result of the event is information related to winning or losing in the virtual battle or information related to the giving probability of the game medium that is changed depending on the result of the event. Next, the computer apparatus receives the information from the player terminal (step S65).

Next, the computer apparatus determines whether or not the event succeeds based on the information received in step S65 (step S66). In a case where the event fails (No in step S66), the process is terminated. In a case where the event succeeds (Yes in step S66), the computer apparatus performs a process of updating the player information such that the information related to the game medium is included in the player information and giving the game medium to the player (step S67).

Next, the computer apparatus transmits the updated information including the information related to the given game medium to the player terminal (step S68). Next, the player terminal receives the information from the computer apparatus (step S69). Next, the player terminal displays a screen for causing the player to select whether or not to share the given game medium with another player (step S70). In a case where the player selects not to share the game medium by providing an operation input (No in step S70), the process is terminated. In a case where the player selects to share the game medium by providing an operation input (Yes in step S70), information indicating the selection to share is transmitted to the computer apparatus from the player terminal (step S71).

The execution of step S70 is preferably limited to a case where the game medium satisfies a predetermined share condition such as a case where the given game medium exceeds predetermined rarity. Specifically, it is preferable to execute step S70 only in a case where the rarity of the given game medium is the highest rarity or the second highest rarity, and in the case of other rarity, to terminate the process without executing a process for sharing with another player (for example, step S70 to step S73). By enabling the player to share only the game medium of high rarity that is highly likely to be desired to be given by a large number of players, the satisfaction of the player can be improved.

Next, the computer apparatus receives the information transmitted from the player terminal in step S71 (step S72). Next, the information related to the game medium given to the player is registered in the storage 13 (step S73), and the process is terminated. For example, the information registered in step S73 preferably includes information related to the player to which the game medium is given, the positional information related to the player terminal in a case where the game medium is given, and information related to a time when the information is registered in the storage. In addition, the information which is related to the game medium and is registered in step S73 may be transmitted to another player terminal in step S55.

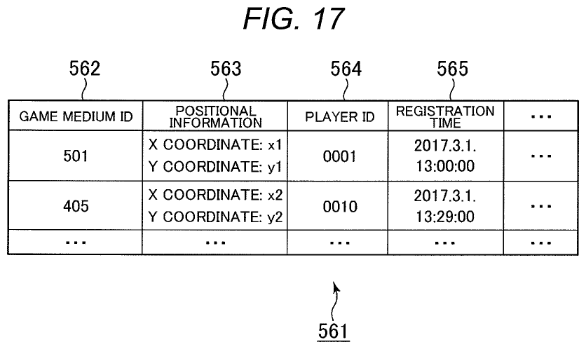

FIG. 17 is one example of a correspondence data table showing the given game medium, the positional information related to the player terminal in a case where the game medium is given, and the like which corresponds to at least one embodiment of the present invention. A correspondence data table 561 stores positional information 563, a player ID 564, and a registration time 565 in association with a game medium ID 562. The correspondence data table 561 is merely one example and may include other information.

The game medium ID 562 is an ID for identifying the game medium selected to be shared with another player in step S70. The positional information 563 is the positional information related to the player terminal in a case where the game medium is given. The positional information stored as the positional information 563 may be the positional information related to the player terminal in step S64 or may be the positional information related to the player terminal in step S71. The player ID 564 is an ID for specifying the player information related to the player who selects to share the game medium with another player in step S70. The registration time 565 is a time at which the information related to the game medium selected to be shared with another player in step S70 is registered in the storage 13.

For example, the positional information 563 can be used for limiting the player terminal transmitting the information related to the game medium shown in the game medium ID 562 or the display position in another player terminal. For example, it is preferable that a game medium corresponding to the game medium ID 562 of “501” is configured to be transmitted to or displayed on only another player terminal positioned within a predetermined range (for example, within a radius of 500 m) from position coordinates “x coordinate x1, y coordinate y1” indicated by the positional information 563. Such a configuration easily maintains regional uniqueness of the game medium, and the ability of interaction between the game and the real world can be increased.

For example, the player ID 564 can be used for displaying the player name of the player selecting to share the game medium on another player terminal. For example, in a case where the game medium corresponding to the game medium ID 562 of “501” is displayed on another player terminal, it is preferable to also display the player name specified by a player ID “0001” on the other player terminal. Such a configuration can increase the satisfaction of the player sharing the game medium.

In addition, for example, the player ID 564 may be used for limiting the player terminal transmitting the information related to the game medium shown in the game medium ID 562. For example, the game medium corresponding to the game medium ID 562 of “501” may be configured to be transmitted to or displayed on only another player terminal of another player having a predetermined relationship (for example, having the friendly relationship or belonging to the same group) with the player specified by the player ID “0001”. In such a configuration, for example, the game medium set to appear in only a specific region can be given without visiting the specific region, and interactivity between players in different spheres of live can be promoted. In addition, a difference between regions that may occur between a region having a small number of players and a region having a large number of players can be reduced.

For example, the registration time 565 can be used for limiting a period in which the information related to the game medium shown in the game medium ID 562 can be transmitted to another player terminal. Specifically, the period in which the game medium can be transmitted to another player terminal can be set to a period from the time shown in the registration time 565 until an elapse of a predetermined time limit (for example, 30 minutes). In a case where the predetermined time limit is set to 30 minutes, information related to the game medium ID 562 of “501” is set to be in a state where the information can be transmitted to another player terminal in a period from “2017.3.1. 13:00:00” shown in the registration time 565 until “2017.3.1. 13:30:00” and is removed from the storage 13 after an elapse of the period. The predetermined time limit can be appropriately set depending on the content of the game.

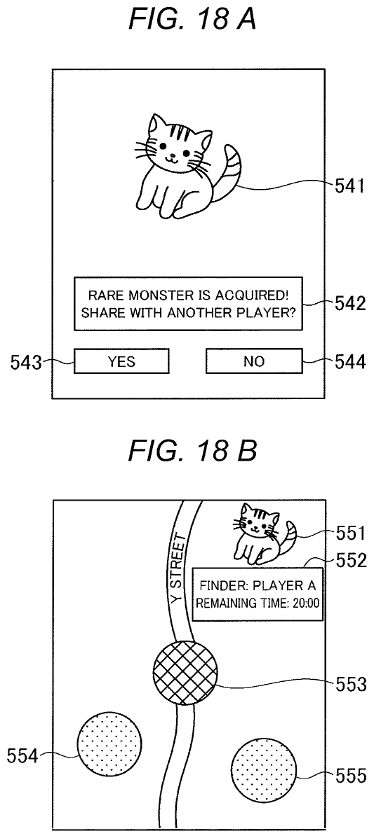

FIG. 18(a) and FIG. 18(b) are one example of a display screen displayed on a player terminal which corresponds to at least one embodiment of the present invention. FIG. 18(a) illustrates one example of a display screen displayed on a player terminal A in a case where a player A receives a game medium. The player terminal A displays a game medium 541, a message field 542, and selection options 543 and 544.

The game medium 541 is a game medium of high rarity given to the player A. The message field 542 displays a message indicating that the player A acquires a game medium of high rarity and a message for inquiring as to whether or not to share the acquired game medium 541 with another player. In a case where the player performs an operation of selecting the selection option 543 displayed as “yes”, information related to the game medium 541 including information related to the player A and information related to the position of the player terminal A in a case where the game medium 541 is acquired is registered in the storage 13 of the computer apparatus. In addition, the storage 13 also stores a time at which the information related to the game medium 541 is registered.

On the other hand, in a case where the player performs an operation of selecting the selection option 544 displayed as “no”, the information related to the game medium is not registered in the storage 13 of the computer apparatus. In the example in FIGS. 18(a) and 18(b), in a case where the acquired game medium is shared, the player information such as the player name of the player and the positional information related to the player terminal is transmitted to another player. However, there also is a player who prefers not to transmit the player information of the player to another player. In order to deal with the request of such a player, it is preferable to cause the player to select whether or not to share the acquired game medium as described above. The player may also be caused to select whether or not to display the player name on another player terminal in addition to selecting whether or not to share the game medium.

In a case where the player A selects the selection option 543 (“yes”), it is preferable to give a predetermined benefit such as an in-game item or an in-game point to the player A. Such a configuration can motivate the player to share the acquired game medium of high rarity. Consequently, interactivity between players can be promoted. The benefit given to the player may be configured to change depending on the number of other players acquiring the shared game medium. For example, in a case where the number of other players acquiring the shared game medium 541 is one, one item A may be given to the player A. In a case where the number of other players is three, three items A may be given to the player A. In a case where the number of other players is five, five items A and one item B having a higher in-game value than item A may be given to the player A. Such a configuration can more strongly motivate the player to share the game medium of high rarity.

FIG. 18(b) illustrates one example of a display screen displayed on a player terminal B of a player B different from the player A in a case where the player selects to share the game medium 541. The player terminal B displays a game medium 551, game medium information 552, a game medium 553 (image is not illustrated), and scratch images 554 and 555.

The game medium 551 is a game medium displayed on the player terminal B based on the information related to the game medium 541 shared by the player A. In addition, a position at which the game medium 551 is displayed on the map is within a predetermined distance (for example, within a radius of 500 m) from the position of the player terminal A in a case where the player A acquires the game medium 541. By limiting the appearance position of the game medium 551 to the above range, regional uniqueness of the appearing game medium can be maintained. The ability of interaction between the game and the real world is increased, and the interest of the game can be improved.

In a case where the player B performs an operation of selecting the game medium 551, an event for acquiring the game medium 551 is executed. In a case where the result of the event satisfies a predetermined giving condition, the game medium 551 is given to the player B. It is preferable that the predetermined giving condition is configured as a condition of higher difficulty than a giving condition in the event executed in the player terminal A. In addition, in a case where the player B receives the game medium 551, it is preferable that the information related to the game medium 551 is configured not to be shared with another player. Such a configuration can provide sociability to the game and prevent a situation in which the game balance is broken by giving the game medium of high rarity to a large number of players.

In addition, in a case where the player B receives the game medium 551, a message may be directly transmitted to the player terminal A from the player terminal B, or to the player terminal A from the player terminal B through the computer apparatus. Such a configuration can promote interactivity between players and improve the interest of the game.

The game medium information 552 displays the player name registered by the player A as a finder of the game medium 551 (game medium 541). By displaying the player name of the player sharing the game medium on another player terminal, the satisfaction of the sharing player can be increased. The player name may not be displayed in the game medium information 552 and, for example, may be displayed during the event for acquiring the game medium 551.

In addition, the game medium information 552 displays the remaining time in which the game medium 551 can be displayed as 20 minutes. In a case where the player B does not perform an operation of selecting the game medium 551 until an elapse of 20 minutes, the game medium 551 is removed from the display screen. The remaining time is preferably decided based on the time at which the information related to the game medium 541 is registered in the storage 13. In a case where the remaining time elapses, the information related to the game medium 541 shared by the player A is removed from the storage 13. Such a configuration can provide sociability to the game and prevent a situation in which the game balance is broken by giving the game medium of high rarity to a large number of players.

The game medium 553 (image is not illustrated) is a game medium selected by the player B from the game media possessed by the player B. The scratch images 554 and 555 are images corresponding to the game media drawn based on the information related to the game medium group corresponding to the region to which the position of the player terminal B belongs.

As one aspect of the seventh embodiment, by deciding the type and position of the displayed game medium on the player terminal side based on the information related to the game medium group corresponding to the region to which the position of the player terminal belongs, an imbalance such that the number of appearing game media varies depending on the position of the player terminal can be resolved, and the game providing high satisfaction in any region can be provided to players.

As one aspect of the seventh embodiment, by deciding the appearing game medium based on the information related to the game medium group corresponding to the region to which the position of the player terminal belongs and giving the appearing game medium to the player, the given game medium can have regional uniqueness, and the interest of the game can be improved.

As one aspect of the seventh embodiment, by setting the game medium given to the player to be givable to another player, the game can have sociability, and interactivity between players can be promoted. In addition, variations of the method of appearance of the game medium can be increased, and the interest of the game can be improved.

As one aspect of the seventh embodiment, by displaying the game medium on the image showing the map of the real world, the ability of interaction between the game and the real world can be increased, and the interest of the game can be improved.

As one aspect of the seventh embodiment, by deciding the appearing game medium on the player terminal side based on the appearance probability set for the game medium, for example, the game medium displayed on each player terminal can be set to be different even in a case where the positions of two or more player terminals in the real world are the same, and the interest of the game can be improved.

As one aspect of the seventh embodiment, by updating the game medium displayed on the player terminal in a case where a predetermined time elapses, for example, a time limit can be set for acquiring the displayed game medium, and the interest of the game can be improved. In addition, since the game medium intentionally left after displaying it by the player can be changed to a new game medium, the convenience of use of the player can be improved.

As one aspect of the seventh embodiment, by displaying the image corresponding to the game medium in a state where the game medium is unidentifiable by the player and then, changing the display of the image corresponding to the game medium displayed in an unidentifiable state to a state where the game medium is identifiable by the player according to a predetermined operation performed on the player terminal, the player can feel that the drawing of the game medium is performed by an operation performed by the player, and the interest of the game can be improved. In addition, for example, by gradually changing the display to an identifiable state according to the predetermined operation performed on the player terminal, an expectation that the game medium displayed in an unidentifiable state may be the game medium desired by the player can be gradually increased, and delight at the time when the game medium is actually the game medium desired by the player can be increased.

As one aspect of the seventh embodiment, by displaying the scratch image at the position at which the game medium is displayed and changing the display of at least a part of the scratch image to the image of the game medium according to a predetermined operation performed on the player terminal, the player can feel joy like actually scraping a scratch lottery ticket, and the interest of the game can be improved.

As one aspect of the seventh embodiment, by displaying the type of scratch image in different states depending on the attribute of the game medium, the player can approximately predict which game medium will be displayed in the case of virtually scraping the scratch image. For example, in a case where the scratch image in a state where the game medium of high rarity may be displayed is displayed, the expectation of the player in the case of scraping the scratch image can be further increased, and the interest of the game can be improved. In addition, the player can have the expectation of the initially displayed state of the scratch image in addition to the expectation of the game medium displayed in the case of scraping the scratch image, and the interest of the game can be improved.

As one aspect of the seventh embodiment, by displaying a plurality of scratch images such that the plurality of scratch images do not overlap with each other, the visibility of the player can be improved. In addition, the occupancy of the display screen by the scratch images which do not overlap with each other on the display screen is higher than that in a case where the scratch images are displayed in overlapping with each other. Thus, the player can feel that a large number of game media appear, and the interest of the game can be improved.

As one aspect of the seventh embodiment, by executing the event for giving the game medium to the player in a case where the image of the displayed game medium is selected by an operation performed on the player terminal, the player can select not to execute the event for the game medium not desired to be given, and the satisfaction of the player can be increased. In addition, by giving the selected game medium not unconditionally but through the execution of the event, the interest of the game can be improved. Furthermore, since the player easily has attachment to the game medium by this configuration, the ratio of players continuing the game can be improved.

In the seventh embodiment, regarding each of the “player terminal”, the “player”, the “computer apparatus”, the “game”, the “game medium”, the “information related to the game medium group”, the “region in the real world”, and the “positional information”, the contents disclosed in the first embodiment can be adopted within a necessary range. In addition, regarding “giving”, and “associating the game medium with the player”, the contents disclosed in the second embodiment can be adopted within a necessary range. In addition, regarding the “predetermined condition”, the contents disclosed in the second embodiment or the third embodiment can be adopted within a necessary range. In addition, regarding the “information related to the game medium”, the contents disclosed in the third embodiment can be adopted within a necessary range. In addition, regarding the “information related to the map”, the contents disclosed in the fourth embodiment can be adopted within a necessary range. In addition, regarding “obtaining the positional information”, the contents disclosed in the fifth embodiment can be adopted within a necessary range.

In addition, in the seventh embodiment, the “attribute of the game medium” specifically refers to a common property of the game medium, a classification standard of the game medium, or the like. For example, the common property of the game medium is exemplified by a property deciding superiority or inferiority with respect to the enemy character in the virtual battle. For example, the classification standard of the game medium is exemplified by a rank of the game medium decided based on the magnitude of the parameter used in the game or the magnitude of the effect in the case of using the game medium, or the rarity of the game medium. In addition, the “rarity” refers to an indicator showing the rareness of the game medium. For example, as the rarity of the game medium is increased, the opportunity for the player to obtain the game medium is decreased.

### APPENDIX

The description of the embodiments described above has been described so that those having ordinary knowledge in the field to which the invention belongs can carry out the following invention.

[1] A game program executed in a computer apparatus connectable by communication to a player terminal operated by a player, the program causing the computer apparatus to function as:
a storage that stores information related to a game medium group configured with a plurality of game media in association with a region in a real world;
a receiver that receives positional information related to a position of the player terminal in the real world; and
a transmitter that transmits, to the player terminal, the information related to the game medium group corresponding to the region to which the position indicated by the received positional information belongs,
wherein the player terminal transmits the positional information related to the position of the player terminal in the real world to the computer apparatus, receives the information related to the game medium group corresponding to the region to which the position of the player terminal in the real world belongs from the computer apparatus, and displays one or more game media constituting the game medium group based on the received information related to the game medium group.
   [2] The game program according to [1], further causing the computer apparatus to function as:
a giver that gives the game medium displayed on the player terminal to the player in a case where a result of a game satisfies a predetermined condition.
   [3] The game program according to [2],
wherein the storage further stores information related to the game medium given to the player by the giver,
the transmitter further transmits the information related to the game medium to another player terminal operated by another player, and
the giver further gives the game medium to another player, in a case where the result of the game in another player terminal satisfies the predetermined condition.
   [4] The game program according to any one of [1] to [3],
wherein the transmitter further transmits information related to a map of the real world corresponding to the region to which the position of the player terminal belongs, and
the player terminal displays one or more game media constituting the game medium group on an image illustrating the map of the real world based on the received information related to the game medium group.
   [5] The game program according to any one of [1] to [4],
wherein the storage stores an appearance probability set for each of one or the plurality of game media constituting the game medium group as the information related to the game medium group, and
the player terminal displays one or more game media constituting the game medium group based on the appearance probability.
   [6] The game program according to any one of [1] to [5],
wherein the player terminal updates the display of the game medium displayed on the player terminal, in a case where a predetermined time elapses.
   [7] The game program according to any one of [1] to [6],
wherein the player terminal displays an image corresponding to the game medium in a state where the game medium is unidentifiable by the player, and changes the display of the image corresponding to the game medium displayed in the unidentifiable state to a state where the game medium is identifiable by the player according to a predetermined operation performed on the player terminal.
   [8] The game program according to any one of [1] to [7],
wherein the player terminal displays a scratch image at a position at which the game medium is displayed, and changes the display of at least a part of the scratch image to an image of the game medium according to a predetermined operation performed on the player terminal.
   [9] The game program according to [8],
wherein the player terminal displays the type of scratch image in different states depending on an attribute of the game medium.
   [10] The game program according to [8] or [9],
wherein the player terminal displays a plurality of scratch images such that the plurality of scratch images do not overlap with each other.
   [11] The game program according to any one of [1] to [10],
wherein the player terminal executes an event for giving the game medium to the player, in a case where an image of the displayed game medium is selected by an operation performed on the player terminal.
   [12] A computer apparatus in which the game program according to any one of [1] to [11] is installed.
   [13] A game system implemented in a player terminal operated by a player and a computer apparatus connectable by communication to the player terminal, the system comprising:
a storage that stores information related to a game medium group configured with a plurality of game media in association with a region in a real world;
an obtainer that obtains positional information related to a position of the player terminal in the real world; and
a display that displays one or more game media constituting the game medium group on the player terminal based on the information related to the game medium group corresponding to the region to which the position indicated by the obtained positional information belongs.
   [14] The game system according to [13], further comprising:
a giver that gives the game medium displayed by the display to the player in a case where a result of a game satisfies a predetermined condition.
   [15] The game system according to [14],
wherein the display displays the game medium on another player terminal operated by another player, in a case where the game medium is given to the player by the giver, and
the giver gives the game medium to another player, in a case where the result of the game in another player terminal satisfies the predetermined condition.
   [16] The game system according to any one of [13] to [15],
wherein the display displays the game medium on a map corresponding to the real world.
   [17] The game system according to any one of [13] to [16],
wherein the display displays the game medium on the player terminal based on an appearance probability set for each of one or the plurality of game media constituting the game medium group.
   [18] The game system according to any one of [13] to [17],
wherein the display updates the display of the game medium displayed on the player terminal, in a case where a predetermined time elapses.
   [19] The game system according to any one of [13] to [18],
wherein the display includes
   an unidentifiable display that displays the game medium in a state unidentifiable by the player, and
   an identifiable display that changes an image displayed by the unidentifiable display to a state where the game medium is identifiable by the player according to a predetermined operation performed on the player terminal.
      [20] The game system according to [19],
wherein the unidentifiable display displays a scratch image, and
the identifiable display changes at least a part of the scratch image to an image of the game medium according to the predetermined operation performed on the player terminal.
   [21] The game system according to [20],
wherein the unidentifiable display displays the type of scratch image in different states depending on an attribute of the game medium.
   [22] The game system according to [20] or [21],
wherein the unidentifiable display displays a plurality of scratch images such that the plurality of scratch images do not overlap with each other.
   [23] The game system according to any one of [13] to [22], further comprising:
an event executioner that executes an event for acquiring the game medium in a case where an image of the game medium displayed by the identifiable display is selected by an operation performed on the player terminal.
   [24] A game program executed in a player terminal in a game system implemented by the player terminal operated by a player and a computer apparatus connectable by communication to the player terminal, the game system storing information related to a game medium group configured with a plurality of game media in association with a region in a real world, receiving positional information related to a position of the player terminal in the real world, and transmitting, to the player terminal, the information related to the game medium group corresponding to the region to which the position indicated by the received positional information belongs, the game program causing the player terminal to function as:
a transmitter that transmits the positional information related to the position of the player terminal in the real world;
a receiver that receives the information related to the game medium group corresponding to the region to which the position of the player terminal in the real world belongs from the computer apparatus; and
a display that displays one or more game media constituting the game medium group based on the received information related to the game medium group.
   [25] A player terminal in which the game program according to [24] is installed.
   [26] A method for controlling a game program executed in a computer apparatus connectable by communication to a player terminal operated by a player, the method comprising:
a storage step of storing information related to a game medium group configured with a plurality of game media in association with a region in a real world;
a reception step of receiving positional information related to a position of the player terminal in the real world; and
a transmission step of transmitting, to the player terminal, the information related to the game medium group corresponding to the region to which the position indicated by the received positional information belongs,
wherein the player terminal transmits the positional information related to the position of the player terminal in the real world to the computer apparatus, receives the information related to the game medium group corresponding to the region to which the position of the player terminal in the real world belongs from the computer apparatus, and displays one or more game media constituting the game medium group based on the received information related to the game medium group.
   [27] A method for controlling a game executed in a game system including a player terminal operated by a player and a computer apparatus connectable by communication to the player terminal, the method comprising:
a storage step of storing information related to a game medium group configured with a plurality of game media in association with a region in a real world;
an obtaining step of obtaining positional information related to a position of the player terminal in the real world; and
a display step of displaying one or more game media constituting the game medium group on the player terminal based on the information related to the game medium group corresponding to the region to which the position indicated by the obtained positional information belongs.

### REFERENCE SIGNS LIST

1 computer apparatus
11 controller
12 RAM
13 storage
14 communication interface
2 game system
3 player terminal
31 controller
32 RAM
33 storage
34 sound processor
35 sound output device
36 sensor unit
37 frame memory
38 graphics processor
39 display unit
40 display screen
41 touch input unit
42 communication interface
43 interface unit
44 input unit
4 communication network

1. A non-transitory computer-readable recording medium including a game program executed in a computer apparatus connectable by communication to a player terminal operated by a player, the program causing the computer apparatus to function as:
a storage that stores information related to a game medium group configured with a plurality of game media in association with a region in a real world;
a receiver that receives positional information related to a position of the player terminal in the real world; and
a transmitter that transmits, to the player terminal, the information related to the game medium group corresponding to the region to which the position indicated by the received positional information belongs,
wherein the player terminal transmits the positional information related to the position of the player terminal in the real world to the computer apparatus, receives the information related to the game medium group corresponding to the region to which the position of the player terminal in the real world belongs from the computer apparatus, and displays one or more game media constituting the game medium group based on the received information related to the game medium group.

2. The non-transitory computer-readable recording medium according to claim 1, further causing the computer apparatus to function as:
a giver that gives the game medium displayed on the player terminal to the player in a case where a result of a game satisfies a predetermined condition.

3. The non-transitory computer-readable recording medium according to claim 2,
wherein the storage further stores information related to the game medium given to the player by the giver,
the transmitter further transmits the information related to the game medium to another player terminal operated by another player, and
the giver further gives the game medium to another player, in a case where the result of the game in another player terminal satisfies the predetermined condition.

4. The non-transitory computer-readable recording medium according to claim 1,
wherein the transmitter further transmits information related to a map of the real world corresponding to the region to which the position of the player terminal belongs, and
the player terminal displays one or more game media constituting the game medium group on an image illustrating the map of the real world based on the received information related to the game medium group.

5. The non-transitory computer-readable recording medium according to claim 1,
wherein the storage stores an appearance probability set for each of one or the plurality of game media constituting the game medium group as the information related to the game medium group, and
the player terminal displays one or more game media constituting the game medium group based on the appearance probability.

6. The non-transitory computer-readable recording medium according to claim 1,
wherein the player terminal updates the display of the game medium displayed on the player terminal, in a case where a predetermined time elapses.

7. The non-transitory computer-readable recording medium according to claim 1,
wherein the player terminal displays an image corresponding to the game medium in a state where the game medium is unidentifiable by the player, and changes the display of the image corresponding to the game medium displayed in the unidentifiable state to a state where the game medium is identifiable by the player according to a predetermined operation performed on the player terminal.

8. The non-transitory computer-readable recording medium according to claim 1,
wherein the player terminal displays a scratch image at a position at which the game medium is displayed, and changes the display of at least a part of the scratch image to an image of the game medium according to a predetermined operation performed on the player terminal.

9. The non-transitory computer-readable recording medium according to claim 8,
wherein the player terminal displays the type of scratch image in different states depending on an attribute of the game medium.

10. The non-transitory computer-readable recording medium according to claim 8,
wherein the player terminal displays a plurality of scratch images such that the plurality of scratch images do not overlap with each other.

11. The non-transitory computer-readable recording medium according to claim 1,
wherein the player terminal executes an event for giving the game medium to the player, in a case where an image of the displayed game medium is selected by an operation performed on the player terminal.

12. (canceled)

13. A game system implemented in a player terminal operated by a player and a computer apparatus connectable by communication to the player terminal, the system comprising:
a storage that stores information related to a game medium group configured with a plurality of game media in association with a region in a real world;
an obtainer that obtains positional information related to a position of the player terminal in the real world; and
a display that displays one or more game media constituting the game medium group on the player terminal based on the information related to the game medium group corresponding to the region to which the position indicated by the obtained positional information belongs.

14. The game system according to claim 13, further comprising:
a giver that gives the game medium displayed by the display to the player in a case where a result of a game satisfies a predetermined condition.

15. The game system according to claim 14,
wherein the display displays the game medium on another player terminal operated by another player, in a case where the game medium is given to the player by the giver, and
the giver gives the game medium to another player, in a case where the result of the game in another player terminal satisfies the predetermined condition.

16. The game system according to claim 13,
wherein the display displays the game medium on a map corresponding to the real world.

17. The game system according to claim 13,
wherein the display displays the game medium on the player terminal based on an appearance probability set for each of one or the plurality of game media constituting the game medium group.

18. The game system according to claim 13,
wherein the display updates the display of the game medium displayed on the player terminal, in a case where a predetermined time elapses.

19. The game system according to claim 13,
wherein the display includes
an unidentifiable display that displays the game medium in a state unidentifiable by the player, and
an identifiable display that changes an image displayed by the unidentifiable display to a state where the game medium is identifiable by the player according to a predetermined operation performed on the player terminal.

20. The game system according to claim 19,
wherein the unidentifiable display displays a scratch image, and
the identifiable display changes at least a part of the scratch image to an image of the game medium according to the predetermined operation performed on the player terminal.

21. A non-transitory computer-readable recording medium including a game program executed in a player terminal in a game system implemented by the player terminal operated by a player and a computer apparatus connectable by communication to the player terminal, the game system storing information related to a game medium group configured with a plurality of game media in association with a region in a real world, receiving positional information related to a position of the player terminal in the real world, and transmitting, to the player terminal, the information related to the game medium group corresponding to the region to which the position indicated by the received positional information belongs, the game program causing the player terminal to function as:
a transmitter that transmits the positional information related to the position of the player terminal in the real world;
a receiver that receives the information related to the game medium group corresponding to the region to which the position of the player terminal in the real world belongs from the computer apparatus; and
a display that displays one or more game media constituting the game medium group based on the received information related to the game medium group.
